(19) United States
(12) Patent Application Publication
(10) Pub. No.: US 2026/0063660 A1
(43) Pub. Date: Mar. 5, 2026

(54) Physical Quantity Sensor

(71) Applicant: SEIKO EPSON CORPORATION, Tokyo (JP)

(72) Inventor: Ryoga MORI, Suwa (JP)

(21) Appl. No.: 19/311,131

(22) Filed: Aug. 27, 2025

(30) Foreign Application Priority Data
Aug. 28, 2024 (JP) 2024-146370

(51) Int. Cl. G01P 15/08

(52) U.S. Cl. CPC G01P 15/08; G01P 2015/0828

(57) ABSTRACT

A physical quantity sensor includes: a base part; a plate-shaped cantilever including a hinge part and a movable part coupled to the base part via the hinge part, the movable part being displaced in relation to the base part with the hinge part serving as a fulcrum; and a physical quantity detection element fixed to the base part and the movable part over the hinge part. The movable part is longer than the hinge part in a second direction intersecting a first direction in which the hinge part and the movable part are arranged when viewed in a plan view of the cantilever, and a free end of the movable part located on a side opposite to the hinge part coincides with an end of the physical quantity detection element on the free end side or is located closer to the hinge part side than the end when viewed in a plan view of the cantilever.

The present application is based on, and claims priority from JP Application Serial Number 2024-146370, filed Aug. 28, 2024, the disclosure of which is hereby incorporated by reference herein in its entirety.

### BACKGROUND

### 1. Technical Field

The present disclosure relates to a physical quantity sensor.

### 2. Related Art

An inertial sensor described in JP-A-2024-033901 includes: a plate-shaped structure including a base part and a cantilever including a thin constricted part and a movable part coupled to the base part via the constricted part; a vibrator fixed to the base part and the movable part over the constricted part; and a mass part disposed at the movable part.

In such an inertial sensor, when acceleration in a Z-axis direction is applied, the movable part is displaced in relation to the base part with the constricted part serving as a fulcrum. Then, due to this displacement, tensile stress or compressive stress is applied to the vibrator, and the resonance frequency of the vibrator changes according to the magnitude of the applied stress. Therefore, the applied acceleration can be detected, based on the change in the resonance frequency of the vibrator.

JP-A-2024-033901 is an example of the related art.

However, in the inertial sensor having such a configuration, when vibration having a frequency close to the resonance frequency of the cantilever is applied from outside, problems such as output abnormality, destruction, and an increase in vibration rectification error (VRE) may occur (hereinafter also referred to as “trouble due to resonance”). Therefore, in order to make such problems less likely to occur, the resonance frequency of the cantilever needs to be sufficiently high in relation to the frequency band in use so as to prevent resonance.

As a method for increasing the resonance frequency of the cantilever, a method of reducing the mass of the movable part may be employed. However, when the mass of the movable part is reduced, there is a problem in that the sensitivity of the inertial sensor decreases. In this way, since an increase in the resonance frequency of the cantilever and an increase in the sensitivity of the physical quantity sensor are in a trade-off relationship, it is difficult to achieve both of these increases in the inertial sensor of JP-A-2024-033901.

### SUMMARY

According to an aspect of the present disclosure, a physical quantity sensor includes: a base part; a plate-shaped cantilever including a hinge part and a movable part coupled to the base part via the hinge part, the movable part being displaced in relation to the base part with the hinge part serving as a fulcrum; and a physical quantity detection element fixed to the base part and the movable part over the hinge part, wherein the movable part is longer than the hinge part in a second direction intersecting a first direction in which the hinge part and the movable part are arranged when viewed in a plan view of the cantilever, and a free end of the movable part located on a side opposite to the hinge part coincides with an end of the physical quantity detection element on the free end side or is located closer to the hinge part side than the end when viewed in a plan view of the cantilever.

### BRIEF DESCRIPTION OF THE DRAWINGS

FIG. 1 is a top view showing the inside of a physical quantity sensor according to a first embodiment.

FIG. 2 is a cross-sectional view taken along a line A-A in FIG. 1.

FIG. 3 is a top view showing a physical quantity sensor element.

FIG. 4 is a top view showing a physical quantity sensor element according to a second embodiment.

### DESCRIPTION OF EMBODIMENTS

A physical quantity sensor according to the present disclosure will now be described in detail, based on embodiments shown in the accompanying drawings.

### First Embodiment

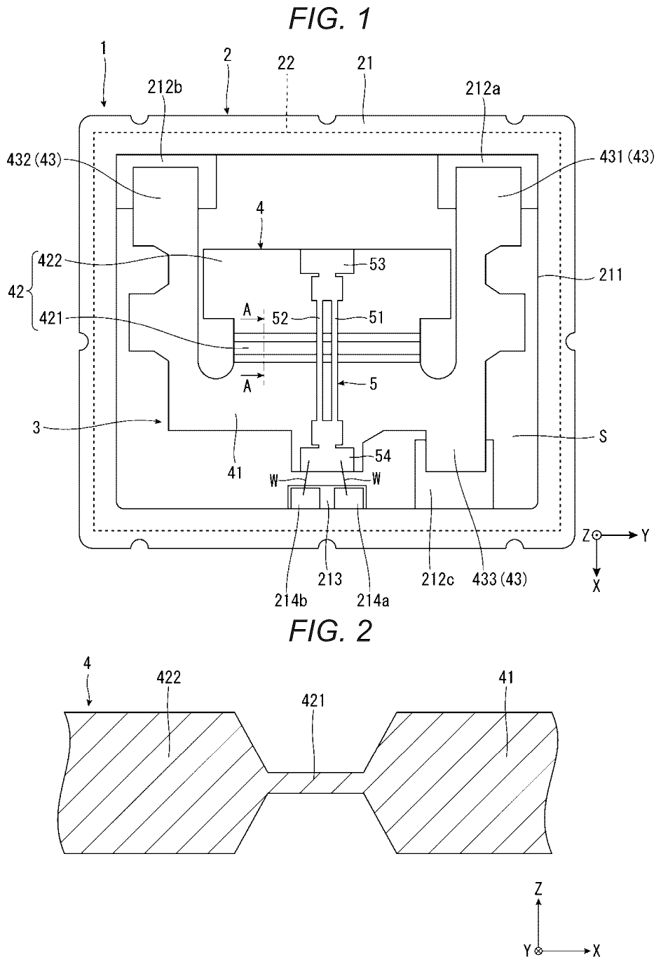

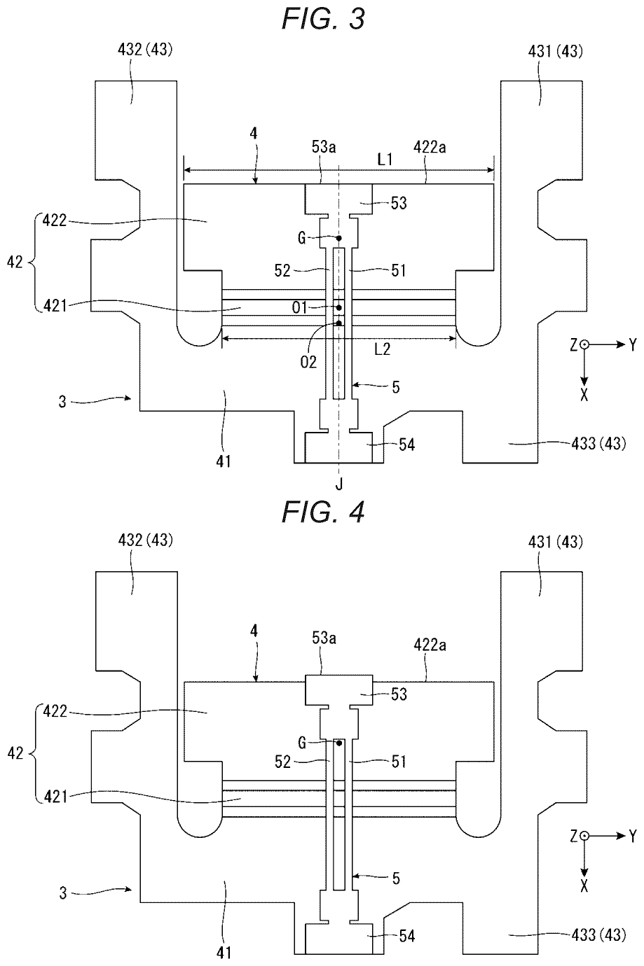

FIG. 1 is a top view showing the inside of a physical quantity sensor according to a first embodiment. FIG. 2 is a cross-sectional view taken along a line A-A in FIG. 1. FIG. 3 is a top view showing a physical quantity sensor element.

In the description below, for the sake of convenience of description, an X axis, a Y axis, and a Z axis, which are three axes orthogonal to one another, are set in the physical quantity sensor. A direction along the X axis is also referred to as an X-axis direction, a direction along the Y axis is also referred to as a Y-axis direction, and a direction along the Z axis is also referred to as a Z-axis direction. A side indicated by an arrowhead on each axis is also referred to as a “positive side”, and an opposite side is also referred to as a “negative side”. Also, the positive side in the Z-axis direction is also referred to as “up”, and the negative side is also referred to as “down”. A plan view from the Z-axis direction, that is, a plan view of a cantilever 42, described later, is also simply referred to as “a plan view”.

A physical quantity sensor 1 shown in FIG. 1 is an acceleration sensor that detects acceleration in the Z-axis direction. The physical quantity sensor 1 includes a package 2 and a physical quantity sensor element 3 accommodated in the package 2.

First, the package 2 will be described. As illustrated in FIG. 1, the package 2 includes a base 21 having a recess 211 opening in the upper surface thereof, and a plate-shaped lid 22 joined to the upper surface of the base 21 via a joint member so as to close the opening of the recess 211. Inside the package 2, an airtight internal space S is formed by the recess 211, and the physical quantity sensor element 3 is accommodated in the internal space S.

For example, the base 21 is made of ceramics such as alumina, and the lid 22 is made of a metal material such as Kovar. Thus, the package 2 having excellent mechanical strength is provided. Also, the difference in linear expansion coefficient between these parts can be suppressed to be small, and the generation of thermal stress can be suppressed. However, the material of each of the base 21 and the lid 22 is not particularly limited. The internal space S is in a reduced-pressure state, preferably in a state close to vacuum. Thus, the viscous resistance decreases, and the vibration characteristics of the physical quantity sensor element 3 are improved. The atmosphere in the internal space S is not particularly limited.

Also, as shown in FIG. 1, the base 21 includes three first pedestals 212a, 212b, 212c and one second pedestal 213 protruding from the bottom surface of the recess 211. The physical quantity sensor element 3 is joined to the first pedestals 212a, 212b, 212c via a joint member, not shown. Internal terminals 214a, 214b are disposed at the second pedestal 213. Each of the internal terminals 214a, 214b is electrically coupled to the physical quantity sensor element 3 via a conductive wire W. Although not shown, two external terminals are disposed at the lower surface of the base 21. These two external terminals are electrically coupled to the internal terminals 214a, 214b respectively via an internal wiring, not shown, that is formed in the base 21. Thus, electrical coupling to the physical quantity sensor element 3 via the external terminal can be implemented.

The package 2 has been described above. The physical quantity sensor element 3 will now be described. As shown in FIG. 1, the physical quantity sensor element 3 includes a substrate structure 4 supported by the first pedestals 212a, 212b, 212c, and a physical quantity detection element 5 disposed at the upper surface of the substrate structure 4.

The substrate structure 4 is a plate-shaped monolithic structure formed of a quartz crystal substrate, and has a flat plate shape along an X-Y plane orthogonal to the Z axis. The cutting angle of the quartz crystal substrate is not particularly limited as long as the quartz crystal substrate functions as a sensor element using a piezoelectric effect, but in the present embodiment, the quartz crystal substrate is a Z-cut with the optical axis laid in the thickness direction. The X axis, the Y axis, and the Z axis shown in the drawings correspond to the crystal axes of the quartz crystal substrate, with the X axis coinciding with the electrical axis of the quartz crystal substrate, the Y axis coinciding with the mechanical axis, and the Z axis coinciding with the optical axis.

The substrate structure 4 includes a base part 41, the cantilever 42 coupled to the base part 41 and displaced in the Z-axis direction, and an arm part 43 supporting the base part 41.

The arm part 43 includes three arm parts 431, 432, 433. The arm parts 431, 432, 433 are disposed around the base part 41 and are each coupled to the base part 41. The substrate structure 4 is joined to the first pedestals 212a, 212b, 212c of the base 21 via a joint member, not shown, at distal end parts of the arm parts 431, 432, 433. Thus, the substrate structure 4 is supported by the base 21.

The cantilever 42 is plate-shaped and includes a hinge part 421 and a movable part 422 coupled to the base part 41 via the hinge part 421. As shown in FIG. 2, the hinge part 421 of the substrate structure 4 is formed at the two main surfaces of the cantilever 42, and these hinge parts 421 overlap each other when viewed in a plan view from the Z-axis direction and are defined as two grooves along the Y-axis direction. Therefore, the hinge part 421 has a smaller thickness (length in the Z-axis direction) than the base part 41 and the movable part 422, which are located on both sides thereof. In the cantilever 42 having such a configuration, the movable part 422 is displaced in the Z-axis direction in relation to the base part 41 with the hinge part 421 serving as a fulcrum.

As shown in FIG. 1, the physical quantity detection element 5 is a double-ended tuning fork type vibration element formed of a quartz crystal substrate. As the physical quantity detection element 5 is formed of the same material as the substrate structure 4, the linear expansion coefficients of the physical quantity detection element 5 and the substrate structure 4 can be made equal to each other. Therefore, thermal stress is less likely to occur between these parts. Thus, thermal stress caused by the difference in linear expansion coefficient between the physical quantity detection element 5 and the substrate structure 4 is not substantially generated, and a force other than acceleration in the Z-axis direction, which is a detection target, is less likely to be applied to the physical quantity detection element 5. Therefore, the physical quantity sensor 1 having high acceleration measurement accuracy is provided.

As shown in FIG. 1, the physical quantity detection element 5 includes two vibration beams 51, 52, a first end part 53 that terminates at one end of the two vibration beams 51, 52, and a second end part 54 that terminates at the other end of the two vibration beams 51, 52. In the physical quantity detection element 5, the vibration beams 51, 52 are disposed along the X axis, and the physical quantity detection element 5 is joined to the movable part 422 via a joint member, not shown, at the first end part 53, and is joined to the base part 41 via a joint member, not shown, at the second end part 54. That is, the physical quantity detection element 5 is fixed to the base part 41 and the movable part 422 over the hinge part 421.

Also, the physical quantity detection element 5 includes a pair of excitation electrodes, not shown, that are provided in the vibration beams 51, 52. When a drive signal of an AC voltage is applied between these excitation electrodes, the vibration beams 51, 52 perform flexural vibration so as to move away from each other or move toward each other in the Y-axis direction. The pair of excitation electrodes are electrically coupled to the internal terminals 214a, 214b via the wire W.

Now, a method for detecting acceleration in the Z-axis direction using the physical quantity sensor element 3 will be described. When acceleration in the Z-axis direction is applied to the physical quantity sensor 1, the movable part 422 is displaced in the Z-axis direction in relation to the base part 41 with the hinge part 421 serving as the fulcrum. Then, due to this displacement, tensile stress or compressive stress is applied to the physical quantity detection element 5, and the resonance frequency of the physical quantity detection element 5 changes according to the magnitude of the applied stress.

Specifically, when acceleration on the positive side in the Z-axis direction is applied, the movable part 422 is displaced to the negative side in the Z-axis direction in relation to the base part 41, and thus tensile stress is applied to the physical quantity detection element 5 and the resonance frequency of the physical quantity detection element 5 increases. On the other hand, when acceleration on the negative side in the Z-axis direction is applied, the movable part 422 is displaced to the positive side in the Z-axis direction in relation to the base part 41, and thus compressive stress is applied to the physical quantity detection element 5 and the resonance frequency of the physical quantity detection element 5 decreases. Therefore, the physical quantity sensor 1 can detect acceleration, based on the change in the resonance frequency of the physical quantity detection element 5. The resonance frequency of the physical quantity detection element 5 can be detected by detecting the potential of a detection electrode, not shown, that is provided at the surface of the vibration beams 51, 52.

The overall configuration of the physical quantity sensor 1 has been briefly described. The cantilever 42, which is also a feature of the physical quantity sensor 1, will now be described in detail.

FIG. 3 is a top view of the physical quantity sensor element 3. As illustrated in FIG. 3, the movable part 422 is longer than the hinge part 421 in the Y-axis direction when viewed in a plan view. In other words, a length L1 of the movable part 422 in the Y-axis direction is larger than a length L2 of the hinge part 421 in the Y-axis direction. Moreover, when viewed in a plan view, a free end 422a of the movable part 422, that is, the end located on the side opposite to the hinge part 421, coincides with an end 53a of the first end part 53 of the physical quantity detection element 5, that is, the end on the same side as the free end 422a. That “the free end 422a of the movable part 422 coincides with the end 53a of the physical quantity detection element 5” means not only a case where the free end 422a and the end 53a coincide with each other when viewed in a plan view, but also a case where the free end 422a and the end 53a are spaced apart from each other to such an extent that there is no sufficient space for disposing another member such as a weight between the free end 422a and the end 53a at the upper surface of the movable part 422.

With such a configuration, the movable part 422 can be made thick and short while a decrease in the mass of the movable part 422 is suppressed, as compared with the related-art configuration. As the movable part 422 is made thick and short in this way, a center of gravity G of the movable part 422 can be brought closer to the hinge part 421 side, that is, the base end part (fixed end) side of the movable part 422, and the resonance frequency of the cantilever 42 can be increased accordingly. As described above, in the cantilever 42 in the present embodiment, the resonance frequency of the cantilever 42 can be increased while the mass of the movable part 422 is sufficiently secured. Therefore, the resonance frequency of the cantilever 42 can be increased while the sensitivity of the physical quantity sensor 1 is sufficiently increased.

As shown in FIG. 3, the center of gravity G of the movable part 422 is located inside the physical quantity detection element 5 when viewed in a plan view. In particular, in the physical quantity sensor 1 according to the present embodiment, the center of gravity G overlaps a central axis J of the physical quantity detection element 5 when viewed in a plan view. With such a configuration, the physical quantity detection element 5 is less likely to be twisted when acceleration on the positive side in the Z-axis direction is applied. Therefore, a decrease in acceleration detection accuracy can be effectively suppressed.

When viewed in a plan view, a center O1 of the hinge part 421 is located closer to the free end 422a side than a center O2 of the physical quantity detection element 5. With such a configuration, the movable part 422 is even shorter and the resonance frequency of the cantilever 42 can be further increased accordingly.

The physical quantity sensor 1 has been described above. As described above, such a physical quantity sensor 1 includes: the base part 41; the plate-shaped cantilever 42 including the hinge part 421 and the movable part 422 coupled to the base part 41 via the hinge part 421, the movable part 422 being displaced in relation to the base part 41 with the hinge part 421 serving as the fulcrum; and the physical quantity detection element 5 fixed to the base part 41 and the movable part 422 over the hinge part 421. Also, the movable part 422 is longer than the hinge part 421 in the Y-axis direction, which is the second direction intersecting the X-axis direction, which is the first direction in which the hinge part 421 and the movable part 422 are arranged, when viewed in a plan view of the cantilever 42. Also, the free end 422a of the movable part 422 located on the side opposite to the hinge part 421 coincides with the end 53a on the free end 422a side of the physical quantity detection element 5 when viewed in a plan view of the cantilever 42. With such a configuration, the movable part 422 can be made thick and short while a decrease in the mass of the movable part 422 is suppressed. Therefore, the resonance frequency of the cantilever 42 can be increased while the sensitivity of the physical quantity sensor 1 is sufficiently increased.

As described above, the center of gravity G of the movable part 422 is located inside the physical quantity detection element 5 when viewed in a plan view of the cantilever 42. With such a configuration, the physical quantity detection element 5 is less likely to be twisted when acceleration on the positive side in the Z-axis direction is applied. Therefore, a decrease in acceleration detection accuracy can be effectively suppressed.

Also, as described above, when viewed in a plan view of the cantilever 42, the center O1 of the hinge part 421 is located closer to the free end 422a side than the center O2 of the physical quantity detection element 5. With such a configuration, the movable part 422 is even shorter and the resonance frequency of the cantilever 42 can be further increased accordingly.

### Second Embodiment

FIG. 4 is a top view showing a physical quantity sensor element according to a second embodiment.

A physical quantity sensor 1 according to the present embodiment is similar to the physical quantity sensor 1 according to the above-described first embodiment except that the configuration of the physical quantity sensor element 3 is different. Therefore, in the description below, the physical quantity sensor 1 according to the present embodiment will be described, focusing on differences from the above-described first embodiment, and descriptions of similar matters will not be repeated. Also, in the drawings of the present embodiment, the same reference numerals are given to configurations similar to those in the above-described embodiment.

As shown in FIG. 4, in the physical quantity sensor element 3 in the present embodiment, the free end 422a of the movable part 422 is located closer to the hinge part 421 side than the end 53a of the first end part 53 of the physical quantity detection element 5 when viewed in a plan view. With such a configuration, as compared with the above-described first embodiment, the center of gravity G of the movable part 422 can be moved even closer to the base end part side and therefore the resonance frequency of the cantilever 42 can be further increased.

The physical quantity sensor 1 has been described above. In such a physical quantity sensor 1, as described above, the free end 422a of the movable part 422 located on the side opposite to the hinge part 421 is located closer to the hinge part 421 side than the end 53a on the free end 422a side of the physical quantity detection element 5 when viewed in a plan view of the cantilever 42. With such a configuration, as compared with the above-described first embodiment, the center of gravity G of the movable part 422 can be moved even closer to the base end part side and therefore the resonance frequency of the cantilever 42 can be further increased.

The second embodiment can achieve effects similar to those of the above-described first embodiment.

While the physical quantity sensor according to the present disclosure has been described based on the illustrated embodiment, the present disclosure is not limited thereto and the configuration of each part can be replaced with any configuration having similar functions. Also, any other configuration may be added to the present disclosure. For example, a weight may be disposed in the movable part 422.

What is claimed is:

1. A physical quantity sensor comprising:
a base part;
a plate-shaped cantilever including a hinge part and a movable part coupled to the base part via the hinge part, the movable part being displaced in relation to the base part with the hinge part serving as a fulcrum; and
a physical quantity detection element fixed to the base part and the movable part over the hinge part, wherein
the movable part is longer than the hinge part in a second direction intersecting a first direction in which the hinge part and the movable part are arranged when viewed in plan view of the cantilever, and
a free end of the movable part located on a side opposite to the hinge part coincides with an end of the physical quantity detection element on a free end side or is located closer to a hinge part side than the end when viewed in the plan view of the cantilever.

2. The physical quantity sensor according to claim 1, wherein
a center of gravity of the movable part is located inside the physical quantity detection element when viewed in the plan view of the cantilever.

3. The physical quantity sensor according to claim 1, wherein
a center of the hinge part is located closer to the free end side than a center of the physical quantity detection element when viewed in the plan view of the cantilever.
